(19) United States
(12) Patent Application Publication
(10) Pub. No.: US 2009/0019439 A1
(43) Pub. Date: Jan. 15, 2009

(54) THREAD POOL MANAGEMENT APPARATUS AND METHOD

(75) Inventors: Ja-Gun Kwon, Seoul (KR); Seung-Bum Chung, Suwon-si (KR); Hyung-Ju Lee, Seongnam-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/871,443

(22) Filed: Oct. 12, 2007

(30) Foreign Application Priority Data
Jul. 12, 2007 (KR) 10-2007-0070032

(51) Int. Cl. G06F 9/46

(52) U.S. Cl. 718/100

(57) ABSTRACT

A thread pool management apparatus and method are provided. The thread pool management method includes setting a management policy for managing a thread pool; and managing the thread pool according to the management policy.

This application claims priority from Korean Patent Application No. 10-2007-0070032 filed on Jul. 12, 2007 in the Korean Intellectual Property Office, the disclosure of which is incorporated herein by reference in its entirety.

### BACKGROUND OF THE INVENTION

1. Field of the Invention

Apparatuses and methods consistent with the present invention relate to thread pool management, to setting a policy for managing a thread pool and managing the thread pool and work threads according to the set policy.

2. Description of the Related Art

FIG. 1 is a block diagram for explaining a related art thread pool management method.

Referring to FIG. 1, if a client 10 requests a thread pool 20 to execute an application thread, the thread pool 20 stores the request for the execution of the application thread in a queue 30. Then, the thread pool 20 assigns the request stored in the queue 30 to an idle work thread 40. Accordingly, the work thread 40 executes the assigned request.

According to the related art thread pool management method described above, the size of a threshold pool, that is, the number of work threads included in the thread pool, cannot be changed.

In addition, since the thread pool is implemented at an application program interface (API) level, there are many limitations on thread logic. In particular, since a method of controlling a specific thread is not available, the performance of the thread pool deteriorates.

Therefore, a thread pool management method which dynamically allocates the size of a thread pool, that is, the number of work threads included in the thread pool, is required.

### SUMMARY OF THE INVENTION

The present invention provides an apparatus and method which dynamically manage a thread pool by creating new work threads when there are requests exceeding a preset processing capacity of the thread pool, processing the requests using the new work threads, and removing idle work threads if the number of idle work threads is greater than a predetermined number.

The present invention also provides an apparatus and method which transforms a work thread into an observer and manages idle work threads using the observer.

The present invention also provides an apparatus and method which manages work threads without limitations on thread logic since a thread pool is implemented at a virtual machine level.

According to an aspect of the present invention, there is provided a thread pool management apparatus including a reference setting module setting a management policy for managing a thread pool; a work thread creation module creating a work thread according to the management policy; and a control module managing the thread pool according to the management policy.

According to another aspect of the present invention, there is provided a thread pool management method including setting a management policy for managing a thread pool; and managing the thread pool according to the management policy.

### BRIEF DESCRIPTION OF THE DRAWINGS

The above and other aspects of the present invention will become more apparent by describing in detail exemplary embodiments thereof with reference to the attached drawings in which:

FIG. 1 is a block diagram for explaining a related art thread pool management method;

FIG. 2 illustrates elements of a thread pool, which makes a request for execution of an application thread and executes the request, at each level according to an exemplary embodiment of the present invention;

FIG. 3 is a table showing mathematical functions of a program, which operates a thread pool management apparatus, and functions of the mathematical functions according to an exemplary embodiment of the present invention;

FIG. 4 is a block diagram of a thread pool management apparatus according to an exemplary embodiment of the present invention;

FIGS. 5 and 6 are flowcharts illustrating a method of managing a thread pool which receives a request for execution of an application thread, creates a work thread, and requests a work thread to execute the request according to an exemplary embodiment of the present invention; and

FIGS. 7 and 8 are flowcharts illustrating a method of managing a thread pool in which a work thread and an observer execute a requested task according to an exemplary embodiment of the present invention.

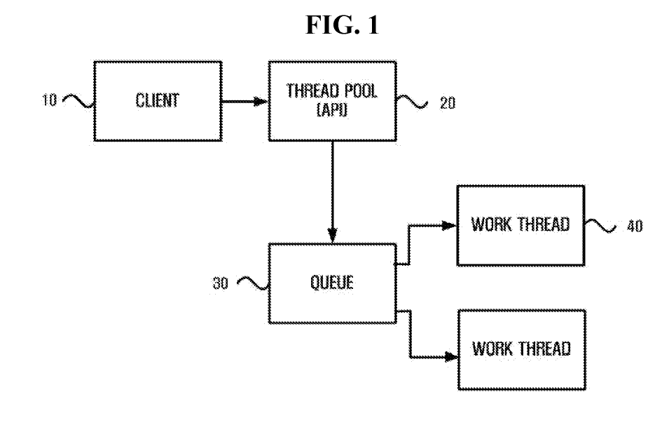

### DETAILED DESCRIPTION OF EXEMPLARY EMBODIMENTS OF THE INVENTION

The present invention will now be described more fully with reference to the accompanying drawings, in which exemplary embodiments of the invention are shown. The invention may, however, be embodied in many different forms and should not be construed as being limited to the embodiments set forth herein; rather, these embodiments are provided so that this disclosure will be thorough and complete, and will fully convey the concept of the invention to those skilled in the art. Like reference numerals in the drawings denote like elements, and thus their description will be omitted.

Exemplary embodiments of the present invention will hereinafter be described in detail with reference to the accompanying drawings.

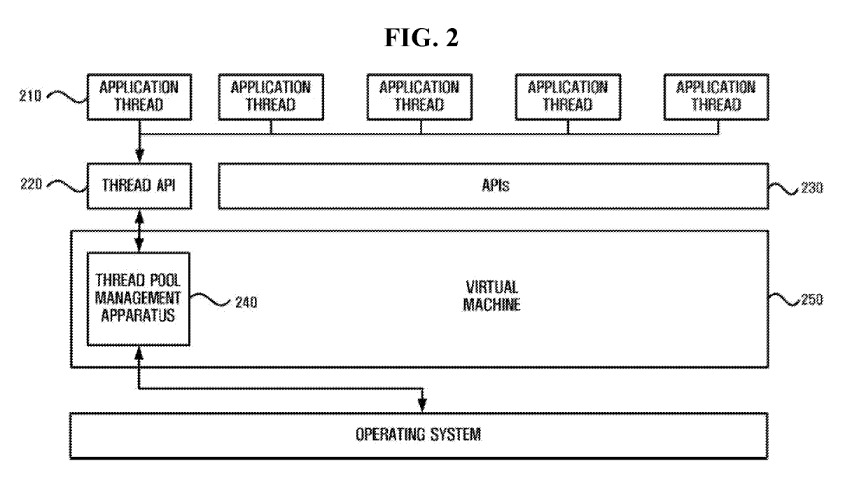

FIG. 2 illustrates elements of a thread pool, which makes a request for execution of an application thread and executes the request, at each level according to an exemplary embodiment of the present invention.

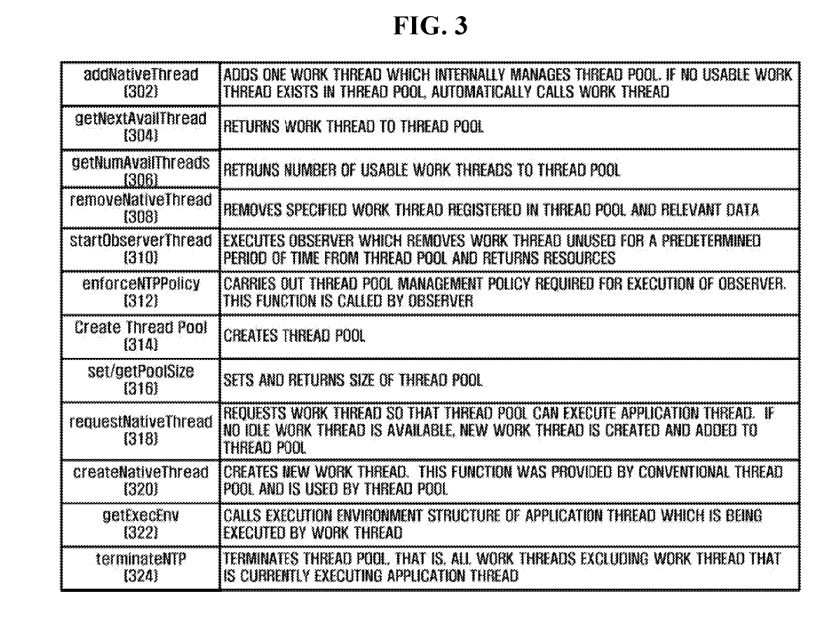

Referring to FIG. 2, a client transmits an application thread 210 for requesting execution of a certain task to a thread API 220. APIs 230 support mathematical functions that perform various functions. In particular, the thread API 220 supports mathematical functions required to execute the application thread 210. Mathematical functions, which support the thread API 220, and functions corresponding to the mathematical functions will be described later with reference to FIG. 3.

A virtual machine 250 is software that converts a program, which interprets and executes a program written in a particular computer language and which is written in a virtual computer language, into intermediate code, called bytecode, using a compiler and interprets and executes the bytecode. When the virtual machine 250 is installed on a computer, the same bytecode can be executed without modification regardless of an instruction set architecture or an operating system (OS) of the computer.

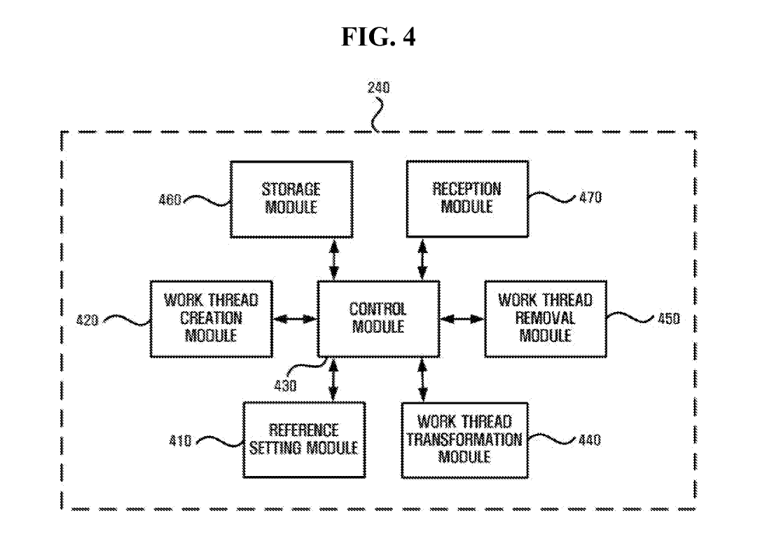

A thread pool management apparatus 240 is positioned at the same level as the virtual machine 250. Therefore, the thread pool management apparatus 240 has all the advantages of the virtual machine 250. Since there is no limit to the use of a lock, the thread pool management apparatus 240 can easily synchronize threads and process the synchronized threads. Elements of the thread pool management apparatus 240 will be described later with reference to FIG. 4.

FIG. 3 is a table showing mathematical functions of a program, which operates a thread pool management apparatus (240), and functions of the mathematical functions according to an exemplary embodiment of the present invention. Mathematical functions required to implement a thread pool and functions of the mathematical functions will now be defined with reference to FIG. 3.

Referring to FIG. 3, addNativeThread 302 adds a work thread which internally manages a thread pool. GetNextAvailThread 304 returns a work thread to the thread pool. In addition, getNumAvailThreads 306 returns the number of usable work threads to the thread pool. RemoveNativeThread 308 removes a specified work thread registered in the thread pool and relevant data. StartObserverThread 310 executes an observer which removes a work thread unused for a predetermined period of time from the thread pool and returns resources. EnforceNTPPolicy 312 carries out a thread pool management policy required for the execution of the observer. CreateThreadPool 314 creates a thread pool. Set/getPoolSize 316 sets the size of the thread pool. RequestNativeThread 318 requests a work thread so that the thread pool can execute an application thread. CreateNativeThread 320 creates a new work thread. GetExecEnv 322 calls an execution environment structure of an application thread which is being executed by a work thread. TerminateNTP 324 terminates the thread pool, that is, terminates all work threads excluding a work thread which is currently executing an application thread. The above mathematical functions and their functions are merely an exemplary embodiment of the present invention and, thus, can be added or modified in order to implement the thread pool management apparatus 240.

FIG. 4 is a block diagram of a thread pool management apparatus 240 according to an exemplary embodiment of the present invention.

Referring to FIG. 4, the thread pool management apparatus 240 includes a reference setting module 410, a work thread creation module 420, a control module 430, a work thread transformation module 440, a work thread removal module 450, a storage module 460, and a reception module 470.

The reference setting module 410 may set a thread pool management policy as follows.

First, the reference setting module 410 determines an initial set size, a minimum set size and a maximum set size of a thread pool. In this case, size denotes the number of work threads.

Second, when the thread pool additionally creates work threads, the reference setting module 410 determines the number of work threads to be created. According to a usage environment or a user's setting, a work thread or a plurality of work threads may be created at one time.

Third, the reference setting module 410 provides a reference value for transforming a work thread into an observer. In this case, the reference value indicates that the number of usable work threads is greater than a combination of the minimum set size of the thread pool and the number of work threads to be removed at a time. In addition, the reference value may indicate that a value of memory occupied by work threads is greater than a predetermined reference value. However, the present invention is not limited thereto, and the reference value may be determined according to a user's setting.

Fourth, the reference setting module 410 determines a cycle at which the observer observes the number of idle work threads. In this case, the cycle is determined by the number of idle work threads. For example, if the number of idle work threads is more than 100, the cycle may be set to 0.5 seconds. If the number of idle work threads is less than 50, the cycle may be set to 2 seconds. However, the present invention is not limited thereto, and the reference value may be determined according to a user's setting or Fibonacci sequence.

Fifth, the reference setting module 410 sets a reference value based on which the observer determines whether to remove idle work threads. In this case, the reference value is determined by the number of idle work threads. As described above, if the observer may search for idle work threads at a cycle of, for example, 0.5 seconds, when the number of idle work threads is more than 100, work threads exceeding 100 are removed using the work thread removal module 450. The reference value may not only be determined according to a user's setting but also may vary according to a usage environment.

When an idle work thread, which will execute an application thread at the request of a client, is not available, the work thread creation module 420 creates work threads at the request of the control module 430. In this case, the number of work threads to be created is equal to the number set by the reference setting module 410.

The work thread transformation module 440 transforms a work thread into an observer or, conversely, transforms an observer into a work thread. As described above, if the reference value is determined by the management policy of the reference setting module 410, the work thread transformation module 440 operates according to the reference value.

If the number of idle work threads found by the observer is greater than the reference value set according to the management policy of the reference setting module 410, the work thread removal module 450 removes the idle work threads.

The storage module 460 stores at least one of the management policy set by the reference setting module 410, an application thread requested by the client, a work thread, and an idle work thread.

The reception module 470 receives a request for the execution of an application thread from the client.

The control module 430 manages and controls each module of the thread pool management apparatus 240 and assigns a request for the execution of an application thread to a work thread.

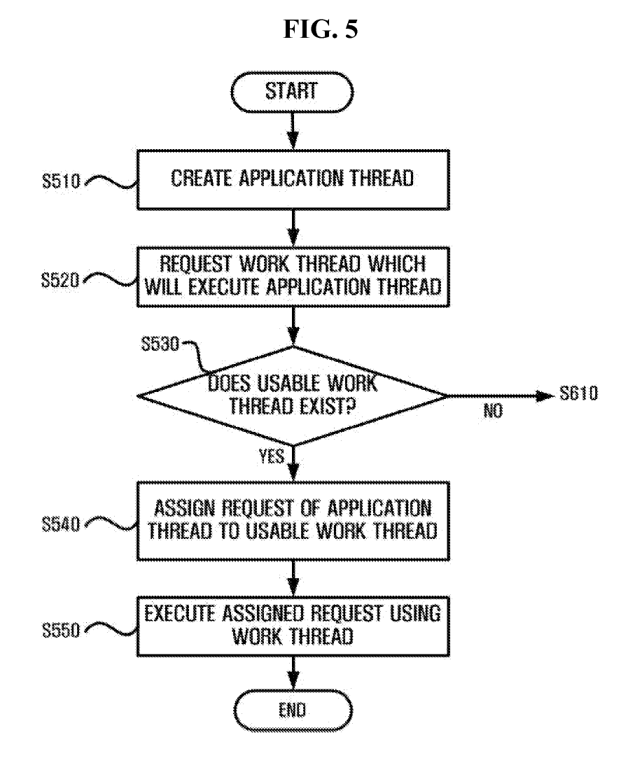

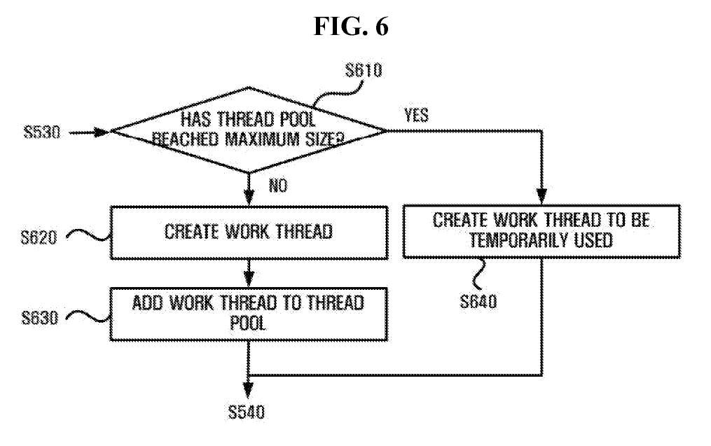

FIGS. 5 and 6 are flowcharts illustrating a method of managing a thread pool which creates a work thread and makes a request for execution of an application thread according to an exemplary embodiment of the present invention.

Referring to FIGS. 5 and 6, a client creates the application thread 210 (operation S510).

The thread pool management apparatus 240 stores a request of the application thread 210 and requests a work thread which will execute the stored request (operation S520).

When requested for the work thread, the thread pool management apparatus 240 determines whether a usable work thread exists (operation S530).

If it is determined that the usable work thread exists, the thread pool management apparatus 240 assigns the request of the application thread 210 to the usable work thread (operation S540). Then, the usable work thread executes the assigned request (operation S550).

If it is determined that the usable work thread does not exist in operation S530, the thread pool management apparatus 240 determines whether a thread pool has reached a maximum size according to a thread pool management policy (operation S610).

If the thread pool has reached the maximum size, the thread pool management apparatus 240 creates a work thread to be temporarily used (operation S640). Then, the thread pool management apparatus 240 assigns the request of the application thread 210 to the work thread that is to be temporarily used (operation S540). The work thread to be temporarily used executes the assigned request (operation S550). The work thread to be temporarily used will disappear after terminating the execution of the assigned request.

If the thread pool has not reached the maximum size, the thread pool management apparatus 240 creates a work thread (operation S620) and adds the created work thread to the thread pool (operation S630). Then, the thread pool management apparatus 240 assigns the request of the application thread 210 to the created work thread (operation S540), and the work thread executes the assigned request (operation S550).

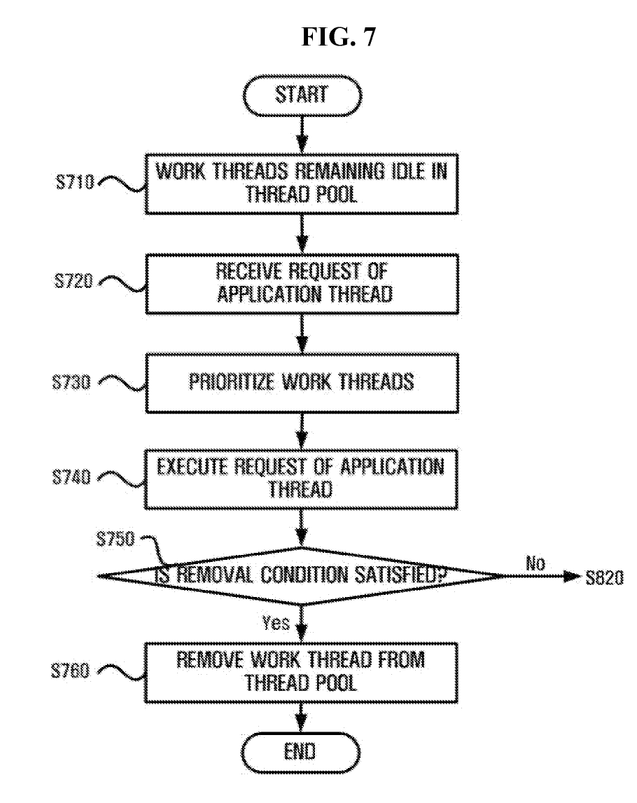

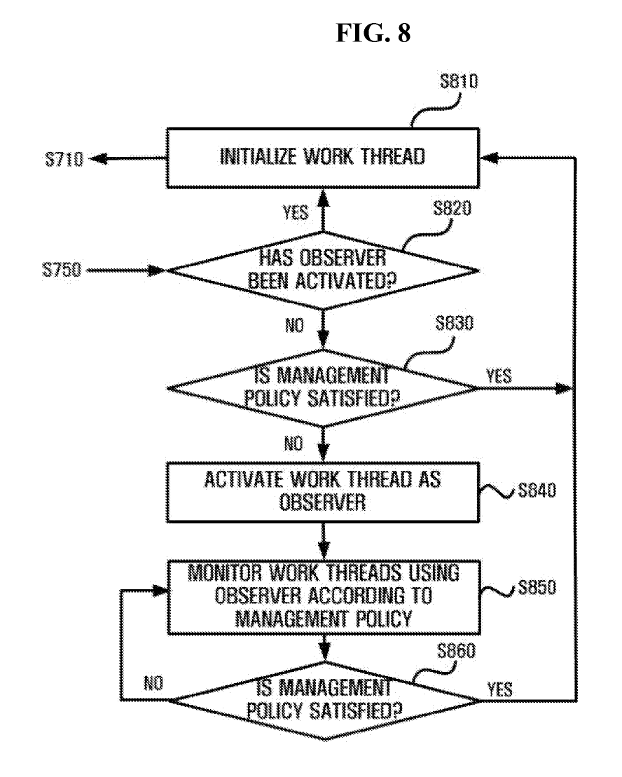

FIGS. 7 and 8 are flowcharts illustrating a method of managing a thread pool in which a work thread and an observer execute a requested task according to an exemplary embodiment of the present invention.

Referring to FIGS. 7 and 8, when work threads remain idle in a thread pool (operation S710), the thread pool management apparatus 240 receives a request of the application thread 210 from a client (operation S720). The thread pool management apparatus 240 prioritizes the work threads (operation S730). Alternatively, the thread pool management apparatus 240 may set daemons for the work threads. A daemon is a program which executes a task related to the operation of a computer system while running in the background. The daemon automatically runs and executes necessary tasks if there occurs work conditions to be processed.

A work thread given with top priority executes the request of the application thread 210 (operation S740).

After the request is executed, the thread pool management apparatus 240 determines whether a condition for removing a work thread is satisfied (operation S750). As set by the reference setting module 410 described above, the removal condition refers to any one of a condition in which a maximum set number of work threads in a thread pool is exceeded, a condition in which the number of idle work threads found by an observer exceeds a reference value, and a user's setting.

If it is determined that the removal condition is satisfied, the thread pool management apparatus 240 removes the work thread from the thread pool (operation S760).

However, if it is determined that the removal condition is not satisfied, the thread pool management apparatus 240 identifies whether the observer has been activated (operation S820).

If the observer has been activated, the thread pool management apparatus 240 initializes the work thread (operation S810) and returns it to the thread pool. Therefore, the work thread remains idle in the thread pool (operation S710).

If the observer has not been activated, the thread pool management apparatus 240 determines whether the thread pool satisfies a thread pool management policy (operation S830). As described above, the thread pool management policy is defined by the reference setting module 410. In particular, the thread pool management policy denotes a reference value for transforming a work thread into an observer. The reference value indicates that the number of usable work threads is greater than a combination of the minimum set size of the thread pool and the number of work threads to be removed at a time. However, the present invention is not limited thereto, and the reference value may be determined according to a user's setting. When the work thread is transformed into an observer, the reference setting module 410 determines a cycle at which the observer observes the number of idle work threads. In this case, the cycle is determined by the number of idle work threads. For example, if the number of idle work threads is more than 100, the cycle may be set to 0.5 seconds. If the number of idle work threads is less than 50, the cycle may be set to 2 seconds. However, the present invention is not limited thereto. The reference value may be determined according to a user's setting or Fibonacci sequence.

Referring back to operation S830, if it is determined that the thread pool satisfies the thread pool management policy, the thread pool management apparatus 240 initializes the work thread (operation S810) and returns it to the thread pool. Accordingly, the work thread remains idle in the thread pool (operation S710).

If it is determined that the thread pool does not satisfy the thread pool management policy, the thread pool management apparatus 240 activates the work thread as the observer (operation S840). The activated observer monitors the work threads according to the thread pool management policy of the thread pool management apparatus 240 (operation S850). The observer monitors work threads and idle threads. If the number of idle work threads violates the thread pool management policy, the observer removes the idle work threads. The observer continuously removes idle work threads until the number of work threads reaches a predetermined number. In this case, the idle work threads are removed in units determined according to a user' setting or a usage environment. For example, if the number of idle work threads is 100, 10 idle work threads may be removed each time.

After monitoring the idle work threads, if the observer determines that the number of idle work threads is less than a predetermined number, the thread pool management apparatus 240, which was reported by the observer on its monitoring results, determines whether the thread pool satisfies the thread pool management policy (operation S860).

If it is determined that the thread pool satisfies the thread pool management policy, the thread pool management policy 240 transforms the observer into a work thread and initializes the work thread (operation S710). The initialized work thread remains idle in the thread pool. However, if it is determined that the thread pool does not satisfy the thread pool management policy, operation S850 is performed. That is, the observer monitors the work threads according to the management policy. This process is repeated until the thread pool management policy is satisfied.

A thread pool management apparatus and method according to the present invention described above can dynamically increase or decrease work threads in a thread pool, thereby increasing the processing speed of an application thread.

In addition, idle work threads can be managed using an observer. Therefore, the processing speed of an application thread can be increased.

Since the thread pool is implemented at a virtual machine level, work threads can be managed without limitations on thread logic. Accordingly, the processing speed of an application thread can be increased.

Also, since the thread pool is implemented at the virtual machine level, it is perfectly compatible with a Java program.

While the present invention has been particularly shown and described with reference to exemplary embodiments thereof, it will be understood by those of ordinary skill in the art that various changes in form and detail may be made therein without departing from the spirit and scope of the present invention as defined by the following claims. The exemplary embodiments should be considered in descriptive sense only and not for purposes of limitation.

What is claimed is:

1. A thread pool management method comprising:
setting a management policy for managing a thread pool; and
managing the thread pool according to the management policy.

2. The method of claim 1, further comprising:
receiving a request to execute an application thread;
assigning the request to a work thread; and
executing the request using the work thread according to the management policy.

3. The method of claim 2, further comprising returning the work thread, which has executed the request, to the thread pool according to the management policy.

4. The method of claim 3, wherein the returning the work thread comprises removing the work thread if a size of the thread pool is greater than at least one of a maximum allowable size.

5. The method of claim 2, further comprising transforming the work thread, which has executed the request, into an observer according to the management policy.

6. The method of claim 5, wherein the observer identifies a number of idle work threads and, if the number of idle work threads is greater than a reference value, removes at least one idle work thread according to the management policy.

7. The method of claim 5, further comprising transforming the observer into a work thread if the number of idle work threads is less than the reference value.

8. The method of claim 6, wherein the reference value is determined according to a user setting or is determined to be a minimum number of work threads in the thread pool.

9. The method of claim 7, wherein the reference value is determined according to a user setting or is determined to be a minimum number of work threads in the thread pool.

10. The method of claim 1, wherein the thread pool comprises at least one of the work thread and the idle work threads.

11. The method of claim 1, wherein the management policy comprises at least one of a maximum size of the thread pool, a minimum size of the thread pool, units in which work threads are created, a cycle at which the observer searches for the idle work threads, units in which the idle work threads are removed, and a user setting.

12. The method of claim 2, wherein the assigning the request comprises creating a work thread if no idle thread exists in the thread pool.

13. A thread pool management apparatus comprising:
a reference setting module which sets a management policy for managing a thread pool;
a work thread creation module which creates a work thread according to the management policy; and
a control module which manages the thread pool according to the management policy.

14. The apparatus of claim 13, further comprising:
a reception module which receives a request to execute an application thread; and
a storage module which stores at least one of the management policy, the request, and the work thread,
wherein the control module assigns the request to the work thread.

15. The apparatus of claim 13, wherein the work thread returns to the storage module after executing the request.

16. The apparatus of claim 14, further comprising a work thread removal module which removes the work thread according to the management policy after the work thread executes the request.

17. The apparatus of claim 14, further comprising a work thread transformation module which transform the work thread, which has executed the request, into an observer according to the management policy.

18. The apparatus of claim 17, wherein the observer identifies a number of idle work threads and, if the number of idle work threads is greater than a reference value, removes at least one idle work thread according to the management policy.

19. The apparatus of claim 17, wherein the work thread transformation module transforms the observer into a work thread if a number of idle work threads is less than the reference value.

20. The apparatus of claim 18, wherein the reference value is determined according to a user setting or is determined to be a minimum number of work threads in the thread pool.

21. The apparatus of claim 19, wherein the reference value is determined according to a user setting or is determined to be a minimum number of work threads in the thread pool.

22. The apparatus of claim 13, wherein the management policy comprises at least one of a maximum size of the thread pool, a minimum size of the thread pool, units in which work threads are created, a cycle at which the observer searches for the idle work threads, units in which the idle work threads are removed, and a user setting.
